(19) United States
(12) Patent Application Publication
(10) Pub. No.: US 2007/0199412 A1
(43) Pub. Date: Aug. 30, 2007

(54) Slide rod with locking unit

(76) Inventor: Chang Chuan Lee, Nantou (TW)

Correspondence Address: LEE CHANG CHUAN, P.O. BOX 2103, TAICHUNG, TW

(21) Appl. No.: 11/362,094

(22) Filed: Feb. 27, 2006

(51) Int. Cl. B25B 23/16; B25G 1/00

(52) U.S. Cl. 81/177.85; 81/177.1; 81/177.5

(57) ABSTRACT

A slide rod with locking unit, including a rod body, a main body and a locking unit. The rod body has two stopper sections. The main body has a downward protruding drive head and an internal cavity. The drive head defines a drive socket communicating with the cavity. A circumferential wall of the drive socket is formed with a ball hole in which a ball body is inlaid. A circumferential wall of the main body is radially formed with a pair of slide holes communicating with the cavity. The locking unit is composed of a cock body, a pad body, an operating pin and a resilient member. The cock body is formed with an internal cavity. A circumferential wall of the cock body is radially formed with a pair of slide slots communicating with the cavity of the cock body. The cock body is fitted in the cavity of the main body to abut against an upper face of the pad body. The operating pin is formed with a stepped section for the ball body to abut against. The resilient member is fitted around the operating pin. The rod body is passed through the slide holes of the main body and the slide slots of the cock body. By means of pressing the cock body, the drive head of the main body can be fitted into a socket or extracted out of the socket.

### BACKGROUND OF THE INVENTION

The present invention is related to a slide rod with locking unit. By means of pressing a cock body, the main body can be fitted into a socket or extracted out of the socket.

FIGS. 7 and 8 show a conventional slide rod structure including a main body 5, a controlling body 6, a rod body 7, a resilient member 8 and a ball body 9. The main body 5 has a protruding drive head 51 and an internal cavity 52. The drive head 51 defines a drive socket 53 communicating with the cavity 52. The circumferential wall of the drive socket 53 is formed with a ball hole 54. The circumferential wall of the main body 5 is formed with a pair of slide holes 55. An abutting boss 61 is disposed on top end of the controlling body 6. In addition, the controlling body 6 is formed with a stepped section 62. The rod body 7 has a plane abutting face 71 and is passed through the slide holes 55 of the main body 5. The resilient member 8 is compressed between the controlling body 6 and the main body 5 to force the controlling body 6 upward and make the abutting boss 61 abut against the abutting face 71 of the rod body 5. The ball body 9 is inlaid in the ball hole 54 of the main body 5 and partially inward protrudes to engage with the stepped section 62 of the controlling body 6.

Referring to FIGS. 9 and 10, when rotating the rod body 7, the controlling body 6 is pressed down into the drive socket 53 of the main body 5. At this time, the resilient member 8 is compressed and the ball body 9 is retracted into the ball hole 54 of the main body. Under such circumstance, the drive head 51 of the main body 5 can be fitted into a socket (not shown) or extracted out of the socket. According to the above arrangement, it is inconvenient to operate/rotate the rod body 7. Moreover, in the case that the rod body 7 is axially excessively moved, the rod body 7 may separate from the main body J.

### SUMMARY OF THE INVENTION

It is therefore a primary object of the present invention to provide a slide rod with locking unit. By means of pressing a cock body of the locking unit, a pad body is forced to push an operating pin into the drive socket of the main body. At this time, a resilient member is compressed and a ball body can be retracted into the ball hole of the main body. Under such circumstance, the drive head of the main body can be fitted into a socket or extracted out of the socket. According to the above arrangement, by means of pressing the cock body, a user can more conveniently operate/control the slide rod. In addition, two stopper sections are respectively disposed at two ends of the rod body, whereby the rod body is prevented from separating from the main body.

According to the above object, the slide rod with locking unit of the present invention includes:

a rod body having two stopper sections respectively disposed near two ends of the rod body;

a main body having a drive head protruding from bottom end of the main body, the main body being formed with an internal cavity, the drive head defining a drive socket communicating with the cavity, a circumferential wall of the drive socket being formed with a ball hole in which a ball body is inlaid, a circumferential wall of the main body being radially formed with a pair of slide holes communicating with the cavity; and

a locking unit composed of a cock body, a pad body, an operating pin and a resilient member, the cock body being formed with an internal cavity having an opening facing the cavity of the main body, a circumferential wall of the cock body being radially formed with a pair of slide slots communicating with the cavity of the cock body, the cock body being fitted in the cavity of the main body, a bottom end of the cock body abutting against an upper face of the pad body, the operating pin being formed with a stepped section corresponding to the ball hole of the main body, whereby the ball body inlaid in the ball hole can abut against the stepped section, the operating pin abutting against a lower face of the pad body, the resilient member being fitted around the operating pin, a bottom end of the resilient member abutting against a bottom wall of the cavity of the main body, the rod body being passed through the slide holes of the main body and the slide slots of the cock body.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a sectional assembled view of the first embodiment of the present invention;

FIG. 4 is a sectional view of the first embodiment of the present invention according to FIG. 3, showing the unlocking operation of the present invention;

FIG. 5 is a sectional view of the first embodiment of the present invention, showing that the stopper section of one end of the rod body prevents the rod body from separating from the main body;

FIG. 6 is a perspective exploded view of a second embodiment of the present invention;

FIG. 7 is a perspective exploded view of a conventional slide rod structure;

FIG. 8 is a partially sectional perspective assembled view of the conventional slide rod structure;

FIG. 9 is a sectional view of the conventional slide rod structure in an unlocked state; and

FIG. 10 is a sectional view of the conventional slide rod structure in a locked state.

### DETAILED DESCRIPTION OF THE PREFERRED EMBODIMENTS

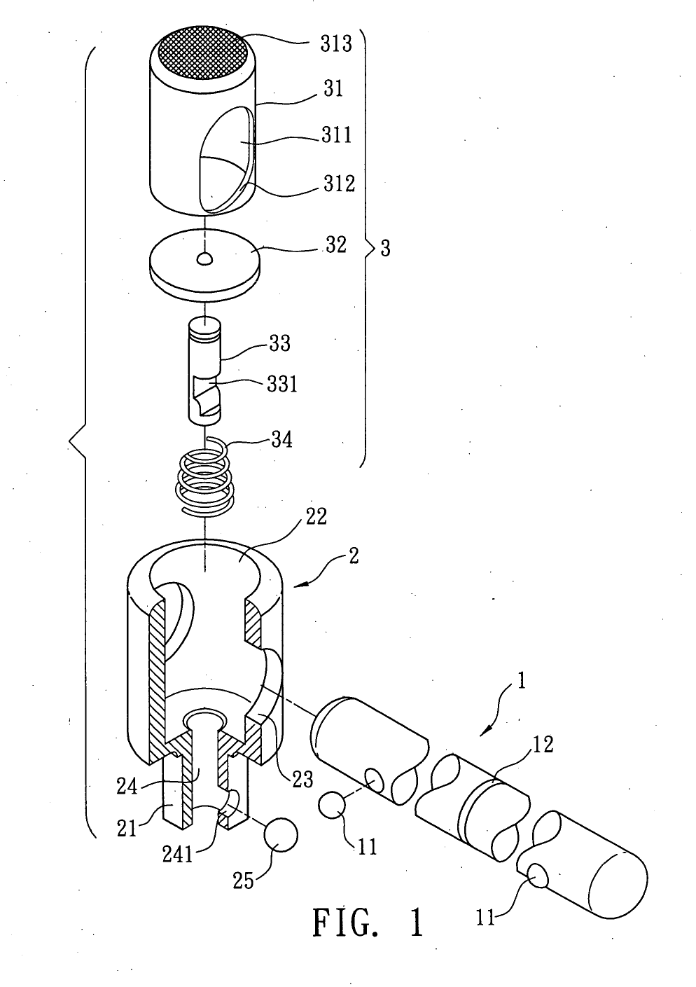

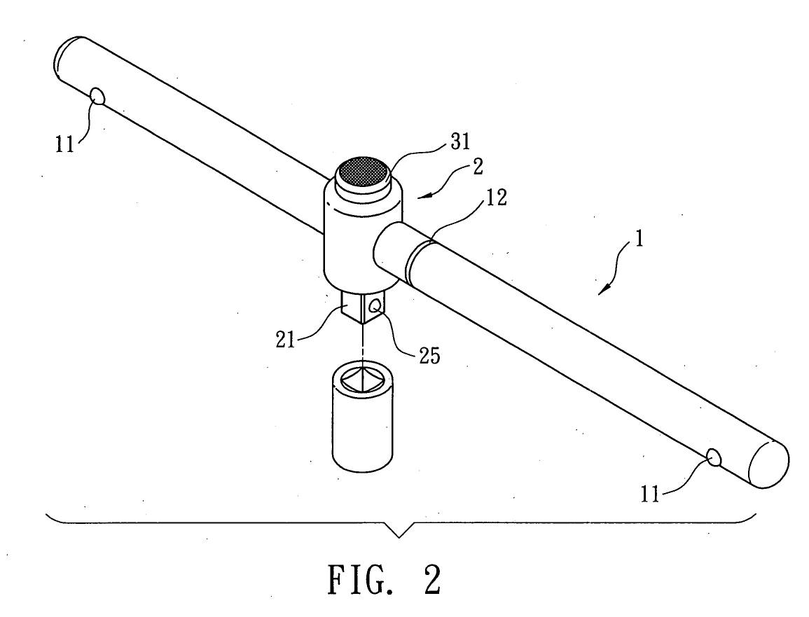

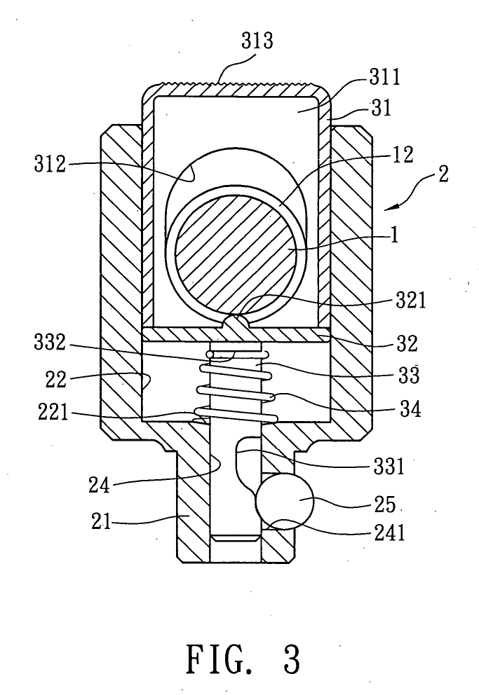

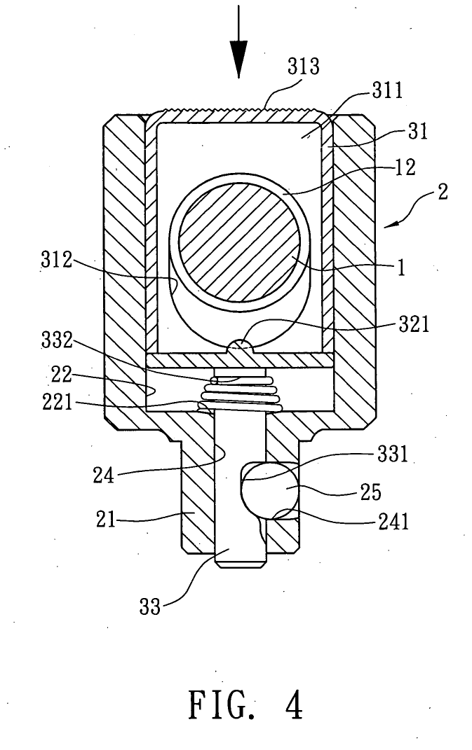

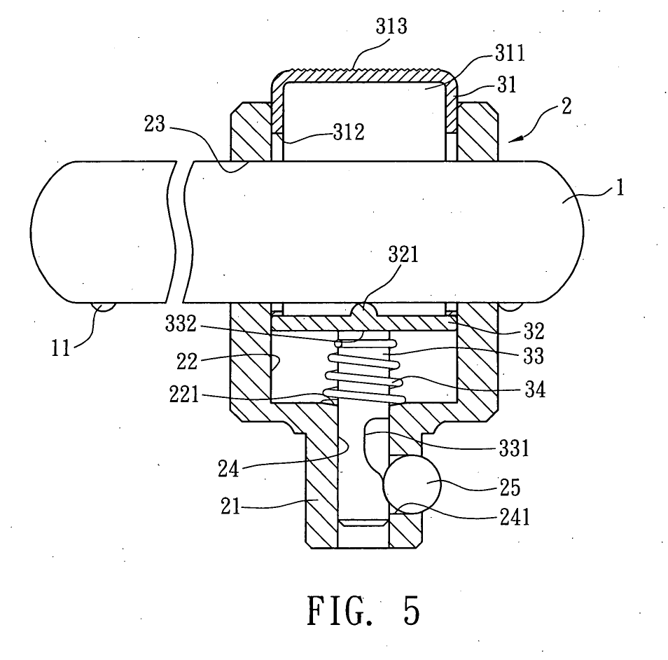

Please refer to FIGS. 1 to 5. The slide rod with locking unit of the present invention includes a rod body 1 having two stopper sections 11 respectively disposed near two ends of the rod body 1. In this embodiment, each stopper section 11 is a ball body inlaid in the rod body 1. At least one annular groove 12 is formed on the rod body 1 between the two stopper sections 11.

The slide rod of the present invention further includes a main body 2 having a drive head 21 protruding from bottom end of the main body 2. The main body 2 is formed with an internal cavity 22. A bottom wall of the cavity 22 is formed with a conic face 221. The drive head 21 defines a drive socket 24 communicating with the cavity 22. The circumferential wall of the drive socket 24 is formed with a ball hole 241 in which a ball body 25 is inlaid. The circumferential wall of the main body 2 is radially formed with a pair of slide holes 23 communicating with the cavity 22.

The slide rod of the present invention further includes a locking unit 3 composed of a cock body 31, a pad body 32, an operating pin 33 and a resilient member 34. The cock body 31 is formed with an internal cavity 311 having an opening facing the cavity 22 of the main body 2. A circumferential wall of the cock body 31 is radially formed with a pair of slide slots 312 communicating with the cavity 311. The cock body 31 is fitted in the cavity 22 of the main body 2. The top end of the cock body 31 has an antislip face 313. The cock body is made from metal or plastic material. A boss 321 is disposed on upper face of the pad body 32. The bottom end of the cock body 31 abuts against the upper face of the pad body 32. The operating pin 33 is formed with a stepped section 331 corresponding to the ball hole 241 of the main body 2, whereby the ball body 25 inlaid in the ball hole 241 can abut against the stepped section 331. The circumference of the operating pin 33 is formed with an annular groove 332 near top end of the operating pin 33. The operating pin 33 abuts against a lower face of the pad body 32. The resilient member 34 is fitted around the operating pin 33. A top end of the resilient member 34 is fixedly inlaid in the annular groove 332 of the operating pin 33. A bottom end of the resilient member 34 abuts against the conic face 221 of the bottom wall of the cavity 22.

The boss 321 of the pad body 32 is engaged in the annular groove 12 of the rod body 1. Accordingly, the position of the main body 2 is restricted to where between the two stopper sections 11 of the rod body 1. The rod body 1 is passed through the slide holes 23 of the main body 2 and the slide slots 312 of the cock body 31.

According to the above arrangement, by means of pressing the cock body 31, the pad body 32 is forced to push the operating pin 33 into the drive socket 24 of the main body 2. At this time, the resilient member 34 is compressed and the ball body 25 can be retracted into the ball hole 241 of the main body 2. Under such circumstance, the drive head 21 of the main body 2 can be fitted into a socket or extracted out of the socket. According to the above arrangement, by means of pressing the cock body 31, a user can more conveniently operate/control the slide rod. In addition, the two stopper sections 11 are respectively disposed at two ends of the rod body 1 and the annular groove 12 is formed between the two stopper sections 11. Therefore, the rod body 1 can be located in a true position without separating from the main body 2

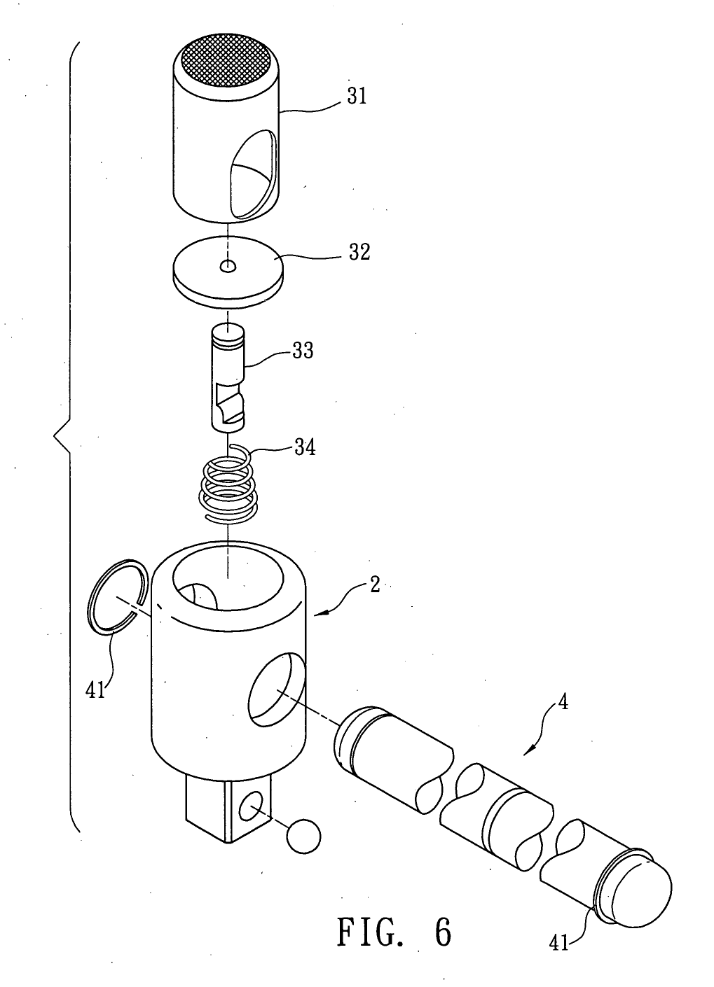

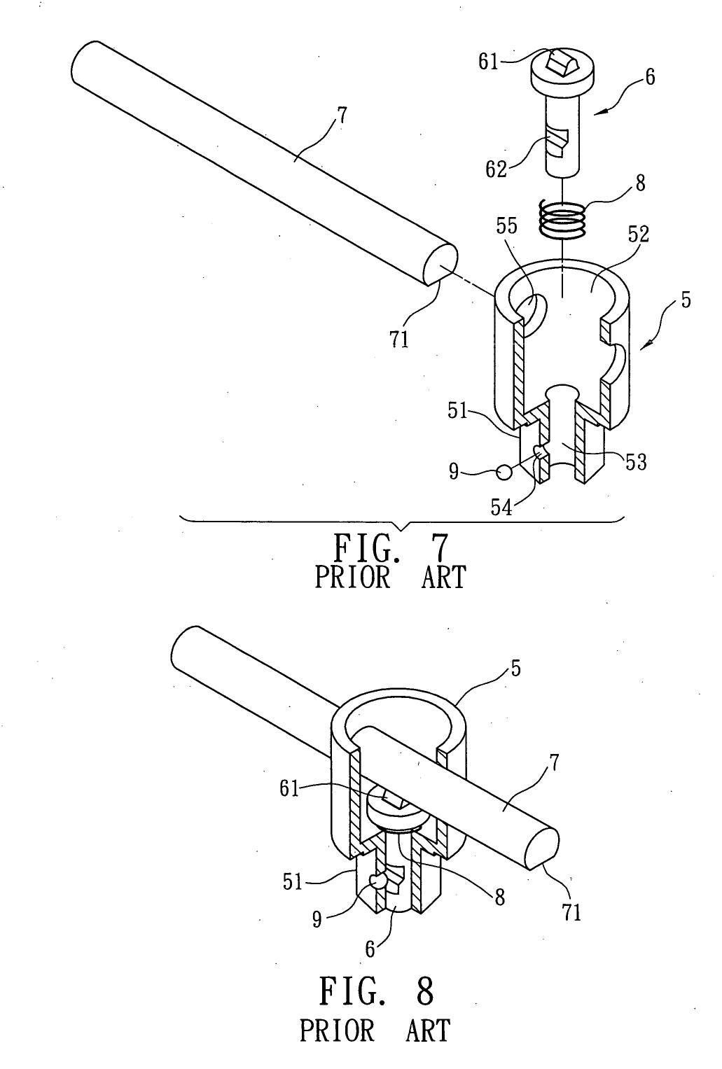

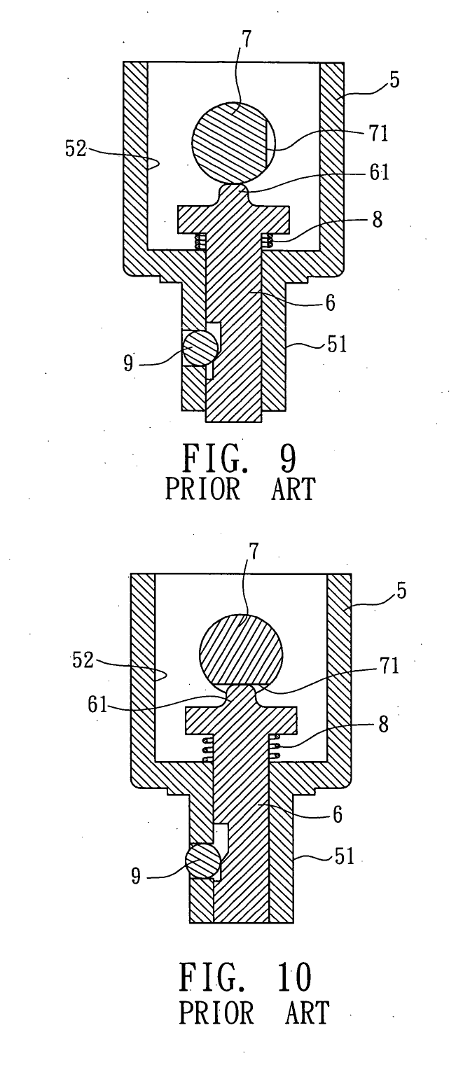

FIG. 6 shows a second embodiment of the present invention, in which the stopper sections 41 of the rod body 4 are two C-shaped retainer rings for preventing the rod body 1 from separating from the main body 2.

The above embodiments are only used to illustrate the present invention, not intended to limit the scope thereof. Many modifications of the above embodiments can be made without departing from the spirit of the present invention.

What is claimed is:

1. A slide rod with locking unit, comprising:
a rod body having two stopper sections respectively disposed near two ends of the rod body;
a main body having a drive head protruding from bottom end of the main body, the main body being formed with an internal cavity, the drive head defining a drive socket communicating with the cavity, a circumferential wall of the drive socket being formed with a ball hole in which a ball body is inlaid, a circumferential wall of the main body being radially formed with a pair of slide holes communicating with the cavity; and
a locking unit composed of a cock body, a pad body, an operating pin and a resilient member, the cock body being formed with an internal cavity having an opening facing the cavity of the main body, a circumferential wall of the cock body being radially formed with a pair of slide slots communicating with the cavity of the cock body, the cock body being fitted in the cavity of the main body, a bottom end of the cock body abutting against an upper face of the pad body, the operating pin being formed with a stepped section corresponding to the ball hole of the main body, whereby the ball body inlaid in the ball hole can abut against the stepped section, the operating pin abutting against a lower face of the pad body, the resilient member being fitted around the operating pin, a bottom end of the resilient member abutting against a bottom wall of the cavity of the main body, the rod body being passed through the slide holes of the main body and the slide slots of the cock body with the main body positioned between the two stopper sections of the rod body.

2. The slide rod with locking unit as claimed in claim 1, wherein the bottom wall of the cavity of the main body is formed with a conic face for the bottom end of the resilient member to abut against.

3. The slide rod with locking unit as claimed in claim 2, wherein the resilient member is a compression spring.

4. The slide rod with locking unit as claimed in claim 1, wherein at least one annular groove is formed on the rod body between the two stopper sections.

5. The slide rod with locking unit as claimed in claim 1, wherein an antislip face is formed on top end of the cock body.

6. The slide rod with locking unit as claimed in claim 1, wherein the cock body is made from metal or plastic material.

7. The slide rod with locking unit as claimed in claim 1, wherein a boss is disposed on the upper face of the pad body for engaging in the annular groove of the rod body to locate the rod body.

8. The slide rod with locking unit as claimed in claim 1, wherein a circumference of the operating pin is formed with an annular groove near top end of the operating pin, a top end of the resilient member being fixedly inlaid in the annular groove.

9. The slide rod with locking unit as claimed in claim 1, wherein each of the stopper sections of the rod body is a ball body inlaid in the rod body.

10. The slide rod with locking unit as claimed in claim 1, wherein each of the stopper sections of the rod body is a C-shaped retainer ring mounted on the rod body.
